(19) United States
(12) Patent Application Publication
(10) Pub. No.: US 2026/0147998 A1
(43) Pub. Date: May 28, 2026

(54) SYSTEMS AND METHODS FOR MINIMIZING MISCLASSIFICATIONS DURING TOKEN CLASSIFICATION USING LARGE LANGUAGE MODELS

(71) Applicant: Capital One Services, LLC, McLean, VA (US)

(72) Inventors: David JACKSON, Santa Monica, CA (US); Alexander SNIFFIN, Atlanta, GA (US)

(73) Assignee: Capital One Services, LLC, McLean, VA (US)

(21) Appl. No.: 18/957,612

(22) Filed: Nov. 22, 2024

(51) Int. Cl. G06F 40/284; G06F 40/247

(52) U.S. Cl. CPC G06F 40/284; G06F 40/247

(57) ABSTRACT

Systems and methods for minimizing misclassifications during token classifications based on large language models are described. The system may process a first input token through a first classification engine to generate a first probability array, wherein the first probability array comprises a first plurality of potential classifications for the first input token and respective probabilities for each of the first plurality of potential classifications. The system may process the first plurality of potential classifications to determine a first set of synonymous classifications among the first plurality of potential classifications. The system may determine a first aggregated probability for the first set based on aggregating the respective probabilities for each of the first plurality of potential classifications in the first set.

### BACKGROUND

A chatbot is a software application designed to simulate human conversation and interact with users through text or voice interfaces. It uses natural language processing (NLP) to understand and respond to inputs from users, enabling automated, real-time communication. Chatbots can be rule-based, where they follow predefined scripts to handle specific queries, or AI-driven, using advanced models like large language models (LLMs) to generate more flexible and natural responses. They are commonly used in customer service, virtual assistants, and other applications to help users answer questions, perform tasks, or retrieve information without the need for human intervention. Chatbots can be integrated into websites, messaging platforms, or voice-enabled systems, making them versatile tools for automating conversations and improving user experience.

Once the chatbot has interpreted an input, it uses a response generation mechanism to formulate an appropriate reply. This can be rule-based, where predefined responses are triggered based on the recognized intent, or AI-driven, where more advanced models, like large language models (LLMs), generate dynamic and context-aware responses. Machine learning-based chatbots use deep learning algorithms to generate responses by predicting the most likely sequence of words based on training data and contextual clues. The response is then passed back to the user, and the chatbot can engage in a continuous conversation, often using memory or contextual awareness to maintain the flow of dialogue across multiple exchanges. Some chatbots are equipped with additional functionalities like handling user data, integrating with external systems, or even executing specific tasks like booking appointments or answering questions.

### SUMMARY

Systems and methods are described herein for novel uses and/or improvements to token classification in large language models. As one example, systems and methods are described herein for minimizing misclassifications during token classification based on large language models using synonym aggregation of probability determinations for input tokens that are processed through a classification engine.

For example, a chatbot may work by leveraging natural language processing (NLP) and machine learning to simulate human-like conversations with users. When a user inputs a query or statement, the chatbot first processes the text through a natural language understanding (NLU) component. The chatbot identifies the user's intent (what the user wants to achieve) and extracts relevant entities (specific information such as dates, names, or products) to fully understand the context of the input.

To improve this classification, the systems and methods may break down the inputted text into distinct tokens. For example, when a user provides an input, the system may first tokenize the text into smaller units, such as words or subwords, to break down the sentence into meaningful components. Each token is then converted into a numerical representation using an embedding layer, which transforms it into a high-dimensional vector capturing the token's syntactic and semantic features. These token embeddings may then be passed through multiple layers of the model, such as transformer layers, which utilize mechanisms like self-attention to analyze the relationships between tokens in the sequence. The self-attention mechanism allows the model to weigh the importance of different tokens based on their context in the sentence. By passing through these layers, the model captures increasingly abstract representations of the input. Once the representations have been processed by the network, the model generates a final output for each token, which is typically a probability distribution over a set of possible classes (e.g., words in a vocabulary for next-word prediction, categories for classification tasks, etc.). This output can be passed to a classification engine, where each token's representation is compared against predefined classes or categories. The classification engine typically uses softmax or another activation function to normalize the output into probabilities, allowing the model to assign the most likely class or label to each token. By processing tokenized text as opposed to processing the text directly, the system may detect underlying syntactic and semantic features that provide more accurate and precise classification.

However, using tokenization for classification, particular classification of language, raises several technical challenges. For example, a single token may have multiple meanings depending on the context (polysemy). Tokenized classification models may misclassify tokens when they are unable to properly disambiguate between different possible meanings of the same token, particularly in short contexts where the model lacks sufficient information to infer the intended meaning. Similarly, models may struggle to handle rare tokens (e.g., based on rare words) that were not seen frequently during training (or at all) as the classification engine may not understand the meaning of these rare or unfamiliar words. These misclassifications and the model's inability to handle rare tokens may compound to greatly impact the effectiveness of the model.

To ensure effectiveness of the model, and to maintain the accuracy and precision of tokenized classification, the systems and methods use synonym aggregation of probability determinations for input tokens that are processed through a classification engine. For example, after generating an input token, the system processes the input token through the classification engine. As opposed to a determined classification, the system receives an array of potential classifications and respective probabilities for those potential classifications. The system then determines which (if any) of the potential classifications are synonyms (e.g., exact matches, fuzzy matches, etc. in terms of word meaning, classification category, etc.). If so, the system aggregates the respective probabilities for any synonyms to generate a final classification. By doing so, any misclassifications and the model's inability to handle rare tokens (and the impact on effectiveness that these issues cause) is mitigated.

In some aspects, systems and methods for minimizing misclassifications during token classifications based on large language models are described. For example, the system may receive a first input token. The system may process the first input token through a first classification engine to generate a first probability array, wherein the first probability array comprises a first plurality of potential classifications for the first input token and respective probabilities for each of the first plurality of potential classifications. The system may process the first plurality of potential classifications to determine a first set of synonymous classifications among the first plurality of potential classifications. The system may determine a first aggregated probability for the first set based on aggregating the respective probabilities for each of the first plurality of potential classifications in the first set. The system may determine a final classification for the first input token based on the first aggregated probability. The system may generate for display, on a user interface, a first output based on the final classification.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a user interface that processes input tokens, in accordance with one or more embodiments.

FIG. 2 shows an illustrative diagram for synonym aggregation of probability determinations for input tokens, in accordance with one or more embodiments.

FIG. 3 shows illustrative components for a system used to minimizing misclassifications during token classifications, in accordance with one or more embodiments.

FIG. 4 shows a flowchart of the steps involved in minimizing misclassifications of tokens, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

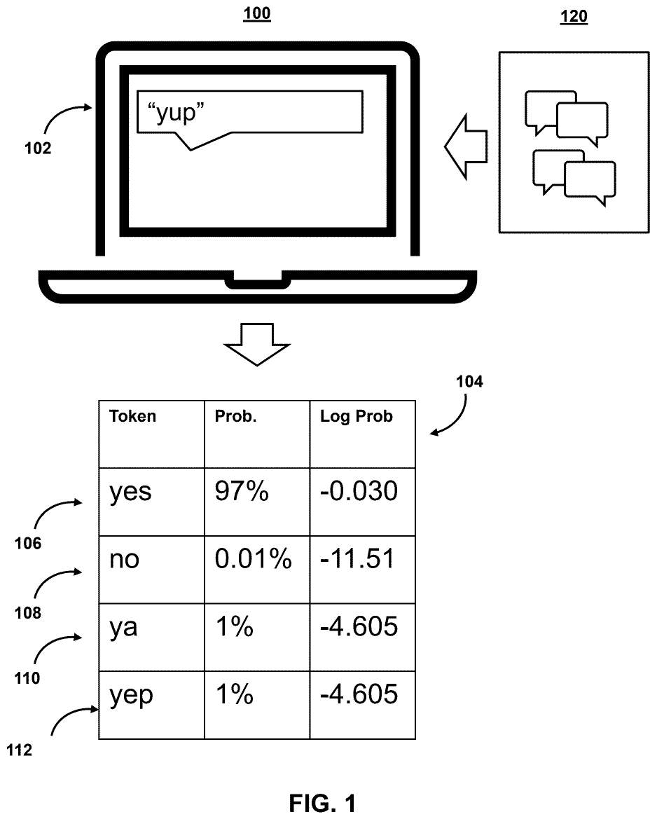

FIG. 1 shows an illustrative diagram for a user interface that processes input tokens, in accordance with one or more embodiments. For example, FIG. 1 may receive text input 102 into user interface 100. A text input in a user interface may be an interactive element that allows users to enter text-based information into a system or application. It is typically presented as a text box or input field where users can type responses, commands, or data, such as search queries, usernames, or passwords. Text inputs are commonly found in web forms, chatbots, search bars, and other interactive interfaces, enabling users to communicate or provide information directly to the system.

The user's input is then processed by the underlying software or service, which may respond by executing a search, validating credentials, generating a response, or performing other tasks based on the text provided. Text input fields can include additional features like placeholders (to indicate the type of information expected), character limits, and validation checks to ensure that the input meets specific criteria.

The system may generate one or more tokens based on text input 102. For example, the system may receive text comprising a token. A token used by a large language model (LLM), for instance, may be a fundamental unit of text that the model processes. Tokens can represent different linguistic elements, such as words, subwords, or even individual characters, depending on the tokenization scheme used. A single word may be represented by one token if it is common, or by multiple subword tokens if it is rare or complex. This allows the model to handle a broad range of language inputs, including uncommon words and misspellings. Tokens may serve as an input to the language model, which then processes these units to generate embeddings—numerical representations that capture the syntactic and semantic features of each token. These embeddings are passed through layers of the model, allowing it to understand and generate human-like text. The model treats tokens as the building blocks of language, and by combining them, it can comprehend the relationships between words and phrases, predict the next word in a sequence, answer questions, or perform translations. In essence, tokens allow the model to break down complex text into pieces it can work with, enabling it to interpret and generate language effectively.

In some embodiments, the system may use a pre-trained language model used to generate byte-pair encodings for input tokens. A system uses a pre-trained language model to generate byte-pair encodings (BPE) for input tokens by first breaking down the input text into smaller units, such as individual characters or subwords. BPE is a compression algorithm that merges frequently occurring character pairs or subword units to form larger tokens that capture common word fragments. The pre-trained language model, which has already learned linguistic patterns from large amounts of text, applies BPE to the input to generate a sequence of tokens that efficiently represents the text. This process starts by applying the BPE algorithm to identify the most frequent character pairs in the training data, which are iteratively merged to create the token vocabulary. When the system receives new input text, it tokenizes the text by matching parts of it to the learned vocabulary, converting words or subwords into tokens. For example, common words or frequent word fragments are represented as single tokens, while rare or complex words may be broken down into multiple tokens. The pre-trained model then uses these BPE tokens as inputs for further processing, such as generating embeddings or predictions. By using BPE, the system can handle a wide range of vocabulary efficiently, including unseen words, while maintaining the flexibility needed for accurate language understanding and generation.

As referred to herein, a “user interface” may comprise a human-computer interaction and communication in a device, and may include display screens, keyboards, a mouse, and the appearance of a desktop. For example, a user interface may comprise a way a user interacts with an application or a website. As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user. User profile data may also include a user characteristic. As referred to herein, “a user characteristic” may include about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be digital representation of a person's identity. The data in the user profile may be generated based on the system actively or passively monitoring.

As shown in FIG. 1, the system may receive user profile 120, which may include a conversational history of a user. For example, the system may record a conversational history of a user in a user profile by storing and tracking the interactions between the user and the system over time. This process typically involves logging each interaction, such as messages, queries, or commands, along with associated metadata like timestamps, user identifiers, and context. The system captures the user's inputs and the corresponding responses, organizing this information in a structured format, often using databases or cloud storage. These logs may include not only the raw text of the conversation but also insights derived from the interaction, such as detected user preferences, intents, or topics of interest.

In natural language processing (NLP), classifying a sequence of tokens may involve analyzing a series of individual words (or subword units) in context to determine an overall category or response. For instance, in a question like “What is the weather today?”, each word contributes to the semantic meaning, and the system uses all tokens collectively to understand the user's intent and classify the request as a weather inquiry. To do this, systems often employ various methods such as recurrent neural networks (RNNs), transformers, or even simpler algorithms, each considering the order and relationship between tokens to generate a prediction. The system might ultimately output a single class or response token that represents the entire input's meaning.

In other scenarios, the system may need to classify a token individually but with respect to the broader input context. This is common in tasks where tokens may map to action-specific classifications, such as an LLM used to direct a machine's functions, like mapping “Go” to “MV” for a move command. Here, each token or command may correspond to a specific action, so individual tokens become actionable based on the classifier's understanding of sequence patterns. Systems dealing with specific domains—like analyzing “How to write a bogiefile in OnePipeline at Capital One”—may also employ classification models trained on domain-specific language. This allows the system to recognize unique tokens and sequences, classifying them within relevant categories or associating them with specialized actions. Such models often depend on labeled training data that teaches the system to recognize these unique sequences and to output either a specific token or category that captures the user's intent in context.

In some embodiments, the conversational history is integrated into the user's profile to personalize future interactions. For instance, a system might refer back to previous conversations to maintain context, remember preferences, or adjust responses based on past behavior. By accumulating and analyzing this historical data, the system can offer more relevant suggestions, streamline repetitive tasks, and improve overall user experience. Privacy and security measures are often implemented to protect the stored data, ensuring that it is only accessed and used in ways consistent with the user's consent and applicable regulations. This ongoing record of user interactions forms the foundation for personalized, context-aware conversations in many modern applications.

The system may process text input 102 (or a first input token based on text input 102) through a first classification engine to generate probability array 104. For example, probability array 104 may comprise a plurality of potential classifications for text input 102 (e.g., classification 106, classification 108, classification 110, and classification 112).

For example, the classification engine may use a neural network to generate vector representations, or embeddings, for each token by mapping tokens to high-dimensional numerical vectors that capture their semantic and syntactic properties. These embeddings are created during the initial stages of the neural network's processing, for example using an embedding layer that transforms each input token into a dense vector. The vectors represent tokens in a way that tokens with similar meanings or roles in a sentence are placed closer together in the vector space, while those with different meanings are positioned farther apart.

The neural network may learn these embeddings through training on large datasets, where it captures the relationships between words and how they are used in various contexts. For example, words with similar meanings, such as “dog” and “canine,” are placed close to each other in this vector space, allowing the classification engine to detect synonyms. The embeddings also allow for similarity analysis, where the model can compare tokens by calculating the cosine similarity or other distance measures between their respective vectors. Tokens with similar vectors are more likely to share similar meanings or functions in language.

Once the embeddings are generated, the classification engine uses them to perform tasks like categorizing tokens, identifying synonyms, or determining the relationships between words. By analyzing the proximity of vectors in the embedding space, the system can efficiently detect word similarities, suggest alternative words, or improve its understanding of the text's overall structure and meaning. This ability to model and compare semantic relationships between tokens is a key strength of neural networks in natural language processing tasks.

The potential classifications may include respective probabilities for each of the first plurality of potential classifications. The respective probability may indicate a likelihood (e.g., expressed as a percentage) that a given input corresponds to a given classification. In some embodiments, the system generates an array of potential classifications, each with a respective probability, by first processing the input through a classification model, such as a neural network. The input, typically a token or sequence of tokens, is transformed into a numerical representation (embedding) that captures its features. This embedding is then passed through several layers of the classification model, where the system analyzes the input based on its learned patterns from training data. At the output layer of the model, the system produces a set of raw scores, or logits, for each potential classification. These scores represent the model's initial assessment of how likely the input belongs to each class, but they are not yet interpretable as probabilities. To convert these logits into a probability distribution, the system applies a softmax function. The softmax function normalizes the scores so that they sum to 1, turning them into probabilities. Each probability represents the likelihood (e.g., expressed as a percentage) that the input corresponds to a specific classification based on the model's analysis.

The result is an array of potential classifications, where each classification is paired with a respective probability. For example, if the system is tasked with classifying an input token, it might generate probabilities for several categories, such as “noun,” “verb,” or “adjective.” These probabilities are often expressed as percentages, indicating how likely the model thinks the input belongs to each class. The system can then use this array to make decisions, such as selecting the classification with the highest probability or considering multiple high-probability options, depending on the task at hand. This process allows the system to make informed and probabilistically sound predictions about the input's classification.

In some embodiments, the probability may be based on a logarithmic scale. Log probabilities may be preferred over direct probabilities, such as percentages, for several important reasons, especially in machine learning and probabilistic models. One key advantage is numerical stability. Probabilities can become extremely small, particularly in tasks involving long sequences or complex combinations of events. Multiplying small probabilities can lead to values so tiny that they risk underflow, which can cause inaccuracies. Log probabilities address this by converting these small values into manageable negative numbers, avoiding underflow issues.

Additionally, log probabilities simplify computations involving multiplication. In many models, such as language models or hidden Markov models, probabilities are multiplied across sequences of events. Multiplying small probabilities leads to even smaller numbers, making the calculations more difficult. By using log probabilities, multiplication is transformed into addition (since log(a×b)=log(a)+log(b)), which is computationally easier and more stable. This also applies when handling conditional or joint probabilities, where long chains of events require multiplying many small values together.

Log probabilities are also more effective for comparison and optimization. Machine learning algorithms, particularly those that rely on maximum likelihood estimation or Bayesian inference, often need to compare probabilities across different models or hypotheses. Log probabilities make this comparison easier and provide smoother gradients for optimization algorithms like gradient descent. Moreover, when summing over many probabilities, such as in language models with large vocabularies, directly summing raw probabilities can lead to overflow. Log probabilities keep values within a manageable range, even when summing across numerous events.

For example, the system may process the first plurality of potential classifications to determine a first set of synonymous classifications among the first plurality of potential classifications. The system may process a plurality of potential classifications to determine a set of synonymous classifications by analyzing the relationships between the classifications, typically using vector representations (embeddings) and similarity measures. Once the system generates an array of potential classifications for a given input, each classification is represented by a numerical vector in a high-dimensional space, where semantically similar classifications are positioned closer together. To identify synonymous classifications, the system compares these vectors using a similarity metric such as cosine similarity or Euclidean distance.

The cosine similarity metric, for example, calculates the cosine of the angle between two vectors, where a value closer to 1 indicates higher similarity. The system examines the vectors corresponding to each potential classification and groups those that have a high similarity score, indicating that the classifications are semantically similar or synonymous. These classifications may represent different terms or labels that convey the same or similar meaning in the given context. Once the system identifies classifications with high similarity, it categorizes them as synonymous and forms a set of synonymous classifications. This approach allows the system to capture nuanced relationships between classifications, such as when two terms are different in form but equivalent in meaning, or when they apply in overlapping contexts. The system can then use this information to refine its predictions, improve classification accuracy, or provide more coherent and context-aware results, ensuring that synonymous classifications are treated consistently across tasks.

The system may determine a first aggregated probability for the first set based on aggregating the respective probabilities for each of the first plurality of potential classifications in the first set. A system determines an aggregated probability for a set of synonymous classifications by combining the respective probabilities of each classification within the set. Once the system identifies a set of potential classifications that are considered synonymous, it aggregates their individual probabilities to produce a single probability that represents the likelihood of the input belonging to this broader classification group.

To aggregate the probabilities, the system typically sums the respective probabilities of all the synonymous classifications in the set. For example, if three synonymous classifications have respective probabilities of 0.2, 0.15, and 0.1, the system adds them together to get an aggregated probability of 0.45. This aggregated probability represents the total likelihood that the input corresponds to any classification within the synonymous set.

In some cases, the system may also apply weighted averaging or normalization techniques to ensure that the aggregation is consistent with the overall probability distribution. By aggregating probabilities in this way, the system can provide a more accurate representation of the likelihood that the input falls under a broader classification category, taking into account the collective probabilities of closely related classifications. This helps the system improve decision-making and handle situations where multiple classifications represent similar or equivalent meanings.

The system may determine a final classification for the first input token based on the first aggregated probability. The system may generate for display, on a user interface, a first output based on the final classification. For example, the output may be a response to text entered by a user.

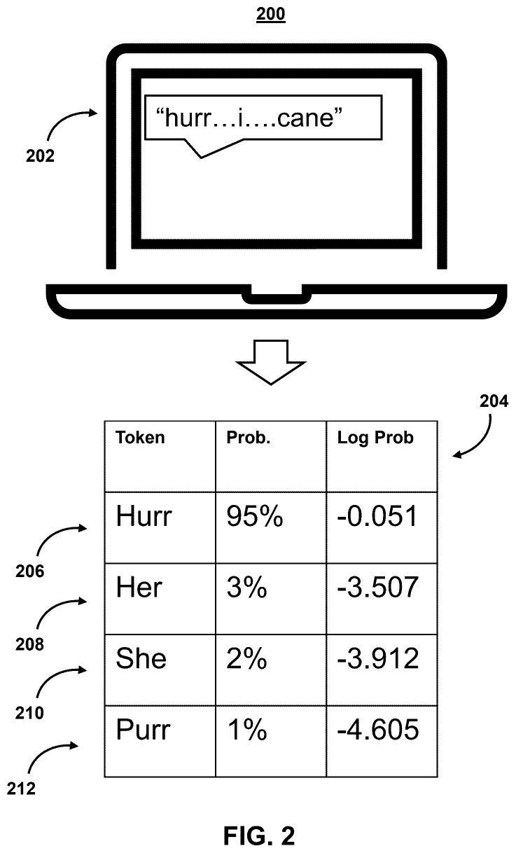

FIG. 2 shows an illustrative diagram for synonym aggregation of probability determinations for input tokens, in accordance with one or more embodiments. In particular, FIG. 2 shows an example of using a component that takes an input token and generates n probable next tokens using a text generation model. For example, text 202 may include the word “hurricane” into user interface 200. This word may comprise multiple input tokens (e.g., the input token “hurr” has been detected).

The system may generate probability array 204, which includes potential classifications for text 202 (e.g., classification 206, classification 208, classification 210, and classification 212). For example, the system may use an embedding model to determine which, if any, of the generated next tokens are synonyms with respect to the original token classifier. For example, the system may be designed to enhance token generation by using classification precision with embedding models and similarity analysis. The process may begin with a user-provided array of tokens, which serve as input to the system. The system has pre-encoded embeddings of all of the tokens used by the language model. These tokens can be searched for by using similarity search algorithms.

When receiving the input, the system may generate n probable next tokens for each classifier token from the text generation model to identifying potential synonyms related to the input. The generated tokens are then fed into an embedding model that produces vector representations of these tokens. The use of embeddings allows for efficient cosine similarity analysis between vectors and identification of synonymous relationships.

In some embodiments, the system may set a threshold from the similarity score, any token with higher than this value is considered as synonym to original classifier token. If the threshold is met for multiple possible classifications, the token is mapped to the classification which produces the highest embedding score. The classification probabilities are then adjusted to take into account the up to N possible synonym probabilities. This mechanism plays a vital role in increasing precision by incorporating synonyms into single-token classifiers. The final classification of the system may include the enhanced classification results, which incorporate information from synonymous tokens identified through similarity analysis and embedding models. By leveraging these techniques, the system improves the accuracy of single-token classifiers.

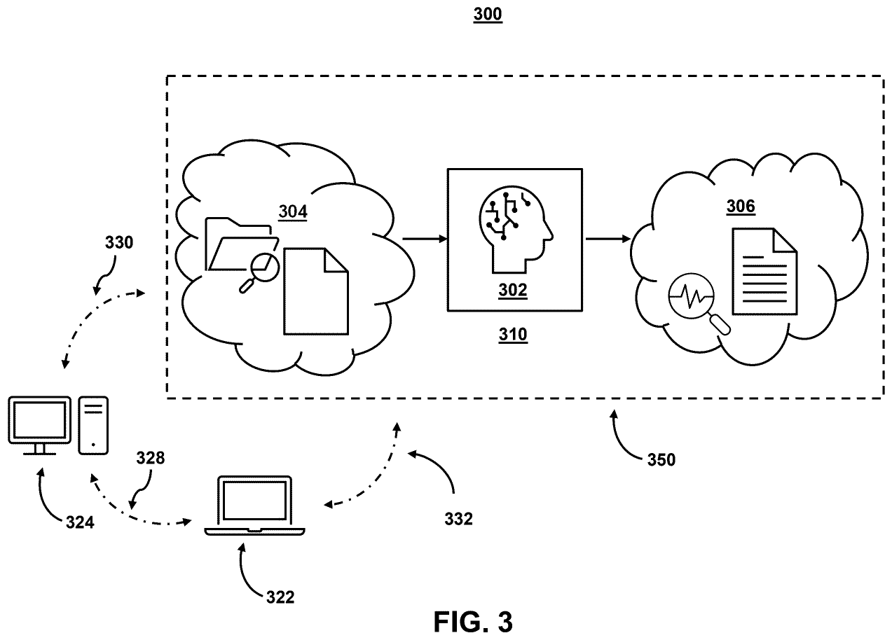

FIG. 3 shows illustrative components for a system used to minimizing misclassifications during token classifications, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication paths or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a token classification).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., a token classification).

In some embodiments, the model (e.g., model 302) may automatically perform actions based on outputs 306. In some embodiments, the model (e.g., model 302) may not perform any actions. The output of the model (e.g., model 302) may be used to classify input tokens. In some embodiments, the system may generate predictions related to financial services. For example, the system may use one or more models and/or application to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

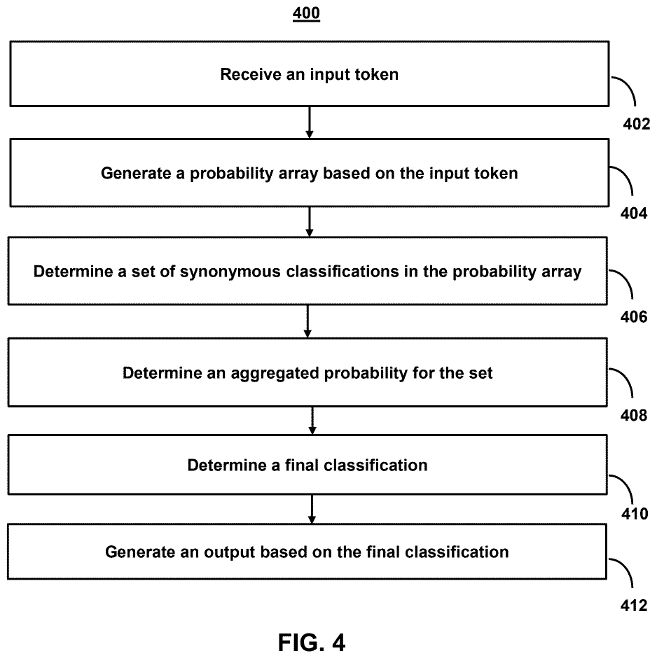

FIG. 4 shows a flowchart of the steps involved in minimizing misclassifications of tokens, in accordance with one or more embodiments. For example, the system may use process 400 (e.g., as implemented on one or more system components described above) in order to for minimize misclassifications during token classifications based on large language models.

At step 402, process 400 (e.g., using one or more components described above) receives an input token. For example, the system may receive a first input token. In some embodiments, the system may receive, at the user interface, first text, determine the first input token based on a syntactic or a semantic feature in the first text, and apply an input filter to the first text to determine whether a response is required. The system may receive first text at the user interface when a user submits input, such as typing a query or providing a command. Once the system captures this input, it processes the text to identify the first input token by analyzing its syntactic or semantic features. Syntactic analysis focuses on the structure of the text, breaking it down into individual tokens (words or subwords) and determining their grammatical roles, such as identifying the subject, verb, or object. Semantic analysis, on the other hand, evaluates the meaning of the tokens in context, allowing the system to understand the concepts or entities being referenced. Based on these features, the system identifies the key token or tokens that represent the most important part of the user's input.

After identifying the first input token, the system applies an input filter to evaluate whether the text requires a response. The input filter uses predefined rules, machine learning models, or natural language processing algorithms to assess the relevance and importance of the input. For example, the filter might check if the text includes a question, command, or keyword that typically warrants a response. If the input contains elements that indicate an actionable request (e.g., a question asking for information or a command requiring execution), the filter will trigger further processing. If no response is required (e.g., if the input is a greeting or a statement not needing follow-up), the system may choose to either acknowledge the input with a neutral response or disregard it. This process ensures that the system efficiently handles user interactions, only generating responses when necessary and relevant, based on the nature of the input and the identified tokens.

In some embodiments, the system may apply the input filter to the first text to determine whether the response is required by determining whether the first text originated from more than one user, and, in response to determining that the first text originated from more than one user, determining that the response is required. A system applies an input filter to the first text to determine whether a response is required by first analyzing the source of the text to check whether it originated from more than one user. The system typically tracks user interactions by associating incoming text with unique user identifiers or session data. When the first text is received, the system inspects the metadata or contextual information linked to the input to identify whether it was submitted by multiple users, such as in a group chat or collaborative interface where several participants are involved.

If the system determines that the text input came from more than one user—either through direct metadata (e.g., multiple user IDs) or by parsing conversational patterns (such as multiple names or markers indicating collaboration)—it recognizes that the interaction is part of a multi-user context. In this scenario, the input filter interprets the presence of multiple contributors as a signal that a coordinated response may be necessary to acknowledge or address the collective input (or no response is needed as the communications are between users). For example, in group discussions or collaborative decision-making tools, text from multiple users could indicate a consensus, request, or joint question that warrants the system's attention. Alternatively, the system may determine that one inquiry is directed to another user, not the system. Upon confirming that the input involves more than one user, the system determines that a response is required and initiates the next steps, such as generating an appropriate reply or taking an action based on the collective input. This approach ensures that the system effectively handles multi-user interactions, responding when necessary to inputs that may reflect group consensus, requests, or queries.

In some embodiments, the system may apply the input filter to the first text to determine whether the response is required by determining the first text is received from a first user, determining a recipient of the first text, determining whether the recipient is a second user, and, in response to determining that the recipient is the second user, determining that the response is required. For example, the system may apply the input filter to the first text to determine whether a response is required by following a series of steps. First, when the first text is received, the system identifies that it has been sent by a first user, typically by associating the input with the user's unique identifier or session data. Next, the system determines the intended recipient of the first text, which could be another user or the system itself. This step often involves analyzing the communication context, such as checking metadata or message routing information to identify who the text is directed toward. After identifying the recipient, the system checks whether the recipient is a second user, rather than the system or an automated process. If the recipient is indeed a second user, this indicates that the text represents a communication between users rather than just a system command or self-reflection. In this case, the system recognizes that a response may not be expected or required.

In some embodiments, the system may apply the input filter to the first text to determine whether the response is required by determining a log probability that the first text is requesting the response and determining that the response is required based on the log probability. The system applies the input filter to the first text to determine whether a response is required by calculating the log probability that the first text is requesting a response. The process begins by analyzing the text using a natural language processing model trained to identify user intents, such as questions, commands, or requests for information. The system evaluates the input's content, structure, and context, breaking it down into tokens and generating vector representations that capture its meaning.

Based on this analysis, the system assigns a probability to various potential interpretations of the text, including the likelihood that the text is asking for a response. The system typically uses log probabilities, which are the logarithmic transformations of these likelihoods, to handle small probability values more efficiently and avoid numerical instability. The log probability reflects the model's confidence that the first text is indeed a request for a response, based on patterns it has learned from large datasets. Once the log probability is calculated, the system applies a threshold to determine if the text is highly likely to be a response request. If the log probability exceeds this threshold, indicating a strong likelihood that the user is expecting a reply, the system determines that a response is required. Conversely, if the log probability is below the threshold, the system may decide that no response is necessary. This approach allows the system to make probabilistically sound decisions about whether to engage with the user, ensuring it responds when appropriate while filtering out inputs that do not require further action.

At step 404, process 400 (e.g., using one or more components described above) generates a probability array based on the input token. For example, the system may process the first input token through a first classification engine to generate a first probability array. The first probability array may comprise a first plurality of potential classifications for the first input token and respective probabilities for each of the first plurality of potential classifications.

In some embodiments, the system may process the first input token through the first classification engine to generate the first probability array, wherein the first probability array comprises the first plurality of potential classifications for the first input token and the respective probabilities for each of the first plurality of potential classifications by receiving a first expression for respective probabilities for each of the first plurality of potential classifications and determining a second expression for respective probabilities for each of the first plurality of potential classifications based on applying a logarithm function to the first expression for respective probabilities for each of the first plurality of potential classifications. For example, the system processes the first input token through the first classification engine to generate the first probability array by first receiving a set of raw probability values, known as the first expression, for each of the potential classifications. These probabilities, often represented as scores or logits, are the initial outputs from the classification engine and indicate the likelihood that the first input token belongs to each of the possible classifications. The first expression represents these raw probabilities as real numbers, but they are not yet in a form that is easy to compare or work with directly, especially when dealing with very small values.

To improve the handling of these probabilities, the system applies a logarithm function to the first expression. This process converts each probability into its logarithmic form, creating what is referred to as the second expression for the respective probabilities of the classifications. By applying the logarithm function, the system transforms the raw probabilities into log probabilities, which have several advantages. Log probabilities make it easier to work with small numbers, avoid underflow issues in computations, and simplify operations such as multiplying probabilities (which becomes the addition of log probabilities).

The result is the second expression, which represents the respective probabilities for each of the potential classifications in a more stable and computationally efficient logarithmic form. This log-transformed probability array is then used in subsequent processing, such as determining the most likely classification for the token, aggregating probabilities, or comparing them with other inputs. By utilizing log probabilities, the system ensures more accurate and reliable classification decisions, especially in scenarios involving complex or extended sequences of input tokens.

In some embodiments, the system processes the first input token through the first classification engine to generate the first probability array by determining a feature input for the first input token and inputting the feature input into a first artificial intelligence model, wherein the first artificial intelligence model is trained to generate vector representations for the first input token. For example, the feature input may be a numerical or vector representation that captures various characteristics of the token, such as its linguistic or contextual properties, including its position in a sentence, the surrounding words, and any semantic meaning derived from the text. These features serve as the foundational data needed for further processing. Once the feature input is determined, the system inputs it into a model, which has been pre-trained to generate vector representations (embeddings) for tokens. This model, often a neural network such as a transformer-based model, is designed to process the feature input and produce a high-dimensional vector that encodes the syntactic and semantic relationships of the token. These vector representations are crucial because they allow the model to understand the token in a broader context and capture its meaning relative to other tokens in the input sequence. After the model generates the vector for the first input token, the system uses this vector to compute the first probability array. The classification engine takes the vector as input and outputs a probability distribution across a predefined set of classifications for the token. The first probability array contains a list of potential classifications—such as parts of speech, named entities, or categories—along with the respective probabilities that the token belongs to each classification. This process enables the system to represent the input token with rich, context-aware embeddings, allowing for accurate classification based on the generated vector representations.

At step 406, process 400 (e.g., using one or more components described above) determines a set of synonymous classifications in the probability array. For example, the system may process the first plurality of potential classifications to determine a first set of synonymous classifications among the first plurality of potential classifications. Additionally or alternatively, the system may process the first plurality of potential classifications to determine a second set of synonymous classifications among the first plurality of potential classifications. The system may determine a second aggregated probability for the second set based on aggregating the respective probabilities for each of the first plurality of potential classifications in the second set. The system may compare the first aggregated probability and the second aggregated probability.

For example, the system may determine potential classifications in a first set of synonymous classifications by analyzing a plurality of potential classifications generated for a given input. Initially, the system evaluates each potential classification based on semantic or contextual similarities, grouping those that represent similar or equivalent meanings into sets of synonymous classifications. For example, the system may identify that several classifications, such as “dog,” “canine,” and “puppy,” are closely related and group them into a first set of synonymous classifications.

Once the system has identified the first set, it calculates an aggregated probability for the set by summing the individual probabilities of each classification within that set. This aggregated probability represents the total likelihood that the input belongs to one of the classifications in the set, reflecting the collective probability of the synonymous classifications. The system then moves on to process the remaining potential classifications, identifying a second set of synonymous classifications from the same plurality of potential classifications. Similarly, it calculates a second aggregated probability for this second set by combining the probabilities of the individual classifications within the set.

After determining the aggregated probabilities for both the first and second sets of synonymous classifications, the system compares these aggregated probabilities. The comparison helps the system decide which set of classifications is more likely to represent the correct interpretation of the input. By aggregating and comparing probabilities in this manner, the system can account for subtle variations in language and synonymy, making a more informed and accurate classification decision that reflects the input's true meaning. This process allows the system to handle complex inputs with multiple potential interpretations by weighing the combined likelihood of synonymous classifications.

At step 408, process 400 (e.g., using one or more components described above) determines an aggregated probability for the set. For example, the system may determine a first aggregated probability for the first set based on aggregating the respective probabilities for each of the first plurality of potential classifications in the first set. A system determines a final classification for the first input token based on the first aggregated probability by utilizing a threshold probability. After calculating the first aggregated probability for a set of synonymous classifications, the system receives a predefined threshold probability, which serves as a benchmark to assess the confidence level required to make a decision. The system then compares the first aggregated probability to the threshold probability to determine whether the classification assigned to the first set should be used as the final classification for the input token. If the first aggregated probability exceeds or meets the threshold, the system interprets this as a high likelihood that the classifications in the first set accurately represent the input token. In this case, the system selects the classification from the first set that has the highest individual probability, or it may assign the entire set's classification as the final classification. If the first aggregated probability falls below the threshold, the system may decide not to use the classification from the first set, potentially considering other sets of classifications or re-evaluating the input based on additional factors. By comparing the aggregated probability to the threshold, the system ensures that it only assigns a final classification when there is sufficient confidence, thereby improving accuracy and reducing the likelihood of misclassification. This method provides a structured way to balance flexibility in classification with the need for reliable, probability-based decision-making.

In some embodiments, the system may determine the final classification for the first input token based on the first aggregated probability by retrieving a classification assigned to the first set and selecting the classification as the final classification. For example, the system determines a final classification for the first input token based on the first aggregated probability by first retrieving the classification assigned to the first set of synonymous classifications. Once the system calculates the first aggregated probability for the set, it uses this probability to assess the likelihood that the input token belongs to one of the classifications within the set. After determining that the aggregated probability meets the necessary confidence level (often in comparison to a predefined threshold), the system identifies the specific classification within the first set that is most representative of the input token. This process involves retrieving the classification from the first set that either has the highest individual probability or is deemed the most semantically appropriate based on the context of the input. Once the classification is retrieved, the system selects it as the final classification for the first input token. By basing this decision on the aggregated probability of the entire set, the system ensures that the final classification reflects a consensus from the related classifications within the set, providing a more accurate and context-aware result. This approach allows the system to handle complex language scenarios, such as when multiple synonymous or related classifications are possible, and ensures that the selected classification is both probabilistically valid and meaningful for the given input.

At step 410, process 400 (e.g., using one or more components described above) determines a final classification. For example, the system may determine a final classification for the first input token based on the first aggregated probability. In some embodiments, the system may determine the final classification for the first input token based on the first aggregated probability by receiving a threshold probability and comparing the first aggregated probability to the threshold probability to determine whether to use a classification assigned to the first set as the final classification.

At step 412, process 400 (e.g., using one or more components described above) generates an output based on the final classification. For example, the system may generate a first output for display on a user interface based on the final classification by first determining the most probable classification for the given input. After processing the input through a classification engine and generating probabilities for various potential classifications, the system selects the final classification, typically the one with the highest probability or the one derived from an aggregated set of synonymous classifications. Once the final classification is identified, the system formats this result into a suitable output for the user interface.

This output may include various elements depending on the specific application. For instance, if the system is classifying text in a chatbot, the final classification might trigger a relevant response or recommendation, which the system prepares for display. If the application is part of a data visualization tool, the final classification may be rendered as a labeled chart, table, or report. The system ensures that the output is presented in a user-friendly format, such as displaying the classification label, associated metadata, or other relevant information.

Finally, the system uses the interface's rendering engine to display the output, ensuring that it is visually clear and contextually appropriate for the user. This might involve updating a text box, generating a notification, or modifying other elements on the screen to reflect the final classification. The system takes into account the layout, design elements, and user interaction possibilities to ensure that the displayed output is easy to interpret and actionable for the user.

In some embodiments, the system may continue to receive tokens and/or generate responses. The system uses the additional tokens to generate new responses and/or modify the responses currently being generated. For example, the system may determine that one or more input tokens correspond to text with multi-tokens (e.g., a word with multiple tokens). The system may receive a second input token and process it through the first classification engine to generate a second probability array, wherein the second probability array comprises a second plurality of potential classifications for the second input token. The system may generate a third probability array based on combining the first plurality of potential classifications and the second plurality of potential classifications.

For example, when the system receives a second input token after processing the first one, it uses the second token to further refine the ongoing response generation process or to adjust the responses already being formed. In cases where the input tokens represent multi-token sequences—such as a word that is tokenized into multiple subunits—the system identifies the connection between these tokens and processes them together to ensure that the meaning is preserved.

When the second input token is received, the system processes it through the first classification engine to generate a second probability array, just as it did with the first token. This second probability array contains a new set of potential classifications for the second token, each associated with its own probability. The system then combines the first and second probability arrays, creating a third probability array that accounts for both tokens. By combining these probability arrays, the system builds a more complete and context-aware representation of the input. This allows the system to generate new responses based on the combined understanding of the first and second tokens, or to modify existing responses that were generated based solely on the first token.

This approach enables the system to handle continuous input and adjust its predictions or responses in real-time as more tokens are received. Whether processing single tokens or multi-token sequences, the system iteratively updates the probability arrays and refines its classification and response generation, ensuring that each new token contributes meaningfully to the overall interpretation of the input. This method allows the system to adapt dynamically to the flow of conversation or text input, generating more accurate and coherent responses.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood by referring to the following enumerated embodiments:
1. A method for minimizing misclassifications during token classifications based on large language models.
2. The method of any one of the preceding embodiments, further comprising receiving a first input token; processing the first input token through a first classification engine to generate a first probability array, wherein the first probability array comprises a first plurality of potential classifications for the first input token and respective probabilities for each of the first plurality of potential classifications; processing the first plurality of potential classifications to determine a first set of synonymous classifications among the first plurality of potential classifications; determining a first aggregated probability for the first set based on aggregating the respective probabilities for each of the first plurality of potential classifications in the first set; determining a final classification for the first input token based on the first aggregated probability; and generating for display, on a user interface, a first output based on the final classification.
3. The method of any one of the preceding embodiments, further comprising; processing the first plurality of potential classifications to determine a second set of synonymous classifications among the first plurality of potential classifications; determining a second aggregated probability for the second set based on aggregating the respective probabilities for each of the first plurality of potential classifications in the second set; and comparing the first aggregated probability and the second aggregated probability.
4. The method of any one of the preceding embodiments, wherein determining the final classification for the first input token based on the first aggregated probability further comprises: receiving a threshold probability; and comparing the first aggregated probability to the threshold probability to determine whether to use a classification assigned to the first set as the final classification.
5. The method of any one of the preceding embodiments, wherein determining the final classification for the first input token based on the first aggregated probability further comprises: retrieving a classification assigned to the first set; and selecting the classification as the final classification.
6. The method of any one of the preceding embodiments, further comprising: receiving a second input token; processing the second input token through the first classification engine to generate a second probability array, wherein the second probability array comprises a second plurality of potential classifications for the second input token; and generating a third probability array based on combining the first plurality of potential classifications and the second plurality of potential classifications.
7. The method of any one of the preceding embodiments, wherein processing the first input token through the first classification engine to generate the first probability array, wherein the first probability array comprises the first plurality of potential classifications for the first input token and the respective probabilities for each of the first plurality of potential classifications further comprises: receiving a first expression for respective probabilities for each of the first plurality of potential classifications; and determining a second expression for respective probabilities for each of the first plurality of potential classification based on applying a logarithm function to the first expression for respective probabilities for each of the first plurality of potential classifications.
8. The method of any one of the preceding embodiments, wherein processing the first input token through the first classification engine to generate the first probability array, wherein the first probability array comprises the first plurality of potential classifications for the first input token and the respective probabilities for each of the first plurality of potential classifications further comprises: determining a feature input for the first input token; and inputting the feature input into a first artificial intelligence model, wherein the first artificial intelligence model is trained to generate vector representations for the first input token.
9. The method of any one of the preceding embodiments, wherein processing the first input token through the first classification engine to generate the first probability array, wherein the first probability array comprises the first plurality of potential classifications for the first input token and the respective probabilities for each of the first plurality of potential classifications further comprises: determining a first probable next token for a first potential classification of the first plurality of potential classifications; determining a second probable next token for a second potential classification of the first plurality of potential classifications; determining a similarity between the first probable next token and the second probable next token; and using the similarity to determine the first set of synonymous classifications among the first plurality of potential classifications.
10. The method of any one of the preceding embodiments, wherein processing the first input token through the first classification engine to generate the first probability array, wherein the first probability array comprises the first plurality of potential classifications for the first input token and the respective probabilities for each of the first plurality of potential classifications further comprises: determining a first user corresponding to the first input token; retrieving a conversation history from a user profile of the first user; determining a supplemental token based on the conversation history; and processing the supplemental token with the first input token in the first classification engine.
11. The method of any one of the preceding embodiments, wherein determining the similarity between the first probable next token and the second probable next token further comprises: determining a first vector representation of the first probable next token; determining a second vector representation of the second probable next token; and determining an inner product space between the first vector representation and the second vector representation.
12. The method of any one of the preceding embodiments, further comprising: receiving, at the user interface, first text; determining the first input token based on a syntactic or a semantic feature in the first text; and applying an input filter to the first text to determine whether a response is required.
13. The method of any one of the preceding embodiments, wherein applying the input filter to the first text to determine whether the response is required further comprises: determining whether the first text originated from more than one user; and in response to determining that the first text originated from more than one user, determining that the response is required.
14. The method of any one of the preceding embodiments, wherein applying the input filter to the first text to determine whether the response is required further comprises: determining the first text is received from a first user; determining a recipient of the first text; determining whether the recipient is a second user; and in response to determining that the recipient is the second user, determining that the response is required.
15. The method of any one of the preceding embodiments, wherein applying the input filter to the first text to determine whether the response is required further comprises: determining a log probability that the first text is requesting the response; and determining that the response is required based on the log probability.
16. One or more non-transitory, computer-readable mediums storing instructions that, when executed by a data processing apparatus, cause the data processing apparatus to perform operations comprising those of any of embodiments 1-15.
17. A system comprising one or more processors; and memory storing instructions that, when executed by the processors, cause the processors to effectuate operations comprising those of any of embodiments 1-15.
18. A system comprising means for performing any of embodiments 1-15.

What is claimed is:

1. A system for minimizing misclassifications during token classifications based on large language models, the system comprising:
one or more processors; and
one or more non-transitory, computer-readable media comprising instructions recorded thereon that when executed by the one or more processors cause operations comprising:
receiving, at a user interface, first text;
determining a first input token based on a syntactic or a semantic feature in the first text;
processing the first input token through a first classification engine to generate a first probability array, wherein the first probability array comprises a first plurality of potential classifications for the first input token and respective logarithmic probabilities for each of the first plurality of potential classifications;
processing the first plurality of potential classifications to determine a first set of synonymous classifications among the first plurality of potential classifications;
determining a first aggregated logarithmic probability for the first set based on aggregating the respective logarithmic probabilities for each of the first plurality of potential classifications in the first set;
determining a final classification for the first input token based on the first aggregated logarithmic probability;
applying an input filter to the final classification to determine whether a response is required;
in response to determining that a response is required, generating for display, on a user interface, a first output based on the final classification, wherein the first output comprises second text responsive to the first text.

2. A method for minimizing misclassifications during token classifications based on large language models, the method comprising:
receiving a first input token;
processing the first input token through a first classification engine to generate a first probability array, wherein the first probability array comprises a first plurality of potential classifications for the first input token and respective probabilities for each of the first plurality of potential classifications;
processing the first plurality of potential classifications to determine a first set of synonymous classifications among the first plurality of potential classifications;
determining a first aggregated probability for the first set based on aggregating the respective probabilities for each of the first plurality of potential classifications in the first set;
determining a final classification for the first input token based on the first aggregated probability; and
generating for display, on a user interface, a first output based on the final classification.

3. The method of claim 2, further comprising;
processing the first plurality of potential classifications to determine a second set of synonymous classifications among the first plurality of potential classifications;
determining a second aggregated probability for the second set based on aggregating the respective probabilities for each of the first plurality of potential classifications in the second set; and
comparing the first aggregated probability and the second aggregated probability.

4. The method of claim 2, wherein determining the final classification for the first input token based on the first aggregated probability further comprises:
receiving a threshold probability; and
comparing the first aggregated probability to the threshold probability to determine whether to use a classification assigned to the first set as the final classification.

5. The method of claim 2, wherein determining the final classification for the first input token based on the first aggregated probability further comprises:
retrieving a classification assigned to the first set; and
selecting the classification as the final classification.

6. The method of claim 2, further comprising:
receiving a second input token;
processing the second input token through the first classification engine to generate a second probability array, wherein the second probability array comprises a second plurality of potential classifications for the second input token; and
generating a third probability array based on combining the first plurality of potential classifications and the second plurality of potential classifications.

7. The method of claim 2, wherein processing the first input token through the first classification engine to generate the first probability array further comprises:
receiving a first expression for respective probabilities for each of the first plurality of potential classifications; and
determining a second expression for respective probabilities for each of the first plurality of potential classifications based on applying a logarithm function to the first expression for respective probabilities for each of the first plurality of potential classifications.

8. The method of claim 2, wherein processing the first input token through the first classification engine to generate the first probability array further comprises:
determining a feature input for the first input token; and
inputting the feature input into a first artificial intelligence model, wherein the first artificial intelligence model is trained to generate vector representations for the first input token.

9. The method of claim 2, wherein processing the first input token through the first classification engine to generate the first probability array further comprises:
determining a first probable next token for a first potential classification of the first plurality of potential classifications;
determining a second probable next token for a second potential classification of the first plurality of potential classifications;
determining a similarity between the first probable next token and the second probable next token; and
using the similarity to determine the first set of synonymous classifications among the first plurality of potential classifications.

10. The method of claim 2, wherein processing the first input token through the first classification engine to generate the first probability array further comprises:
determining a first user corresponding to the first input token;
retrieving a conversation history from a user profile of the first user;
determining a supplemental token based on the conversation history; and
processing the supplemental token with the first input token in the first classification engine.

11. The method of claim 9, wherein determining the similarity between the first probable next token and the second probable next token further comprises:
determining a first vector representation of the first probable next token;
determining a second vector representation of the second probable next token; and
determining an inner product space between the first vector representation and the second vector representation.

12. The method of claim 2, further comprising:
receiving, at the user interface, first text;
determining the first input token based on a syntactic or a semantic feature in the first text; and
applying an input filter to the first text to determine whether a response is required.

13. The method of claim 12, wherein applying the input filter to the first text to determine whether the response is required further comprises:
determining whether the first text originated from more than one user; and
in response to determining that the first text originated from more than one user, determining that the response is required.

14. The method of claim 12, wherein applying the input filter to the first text to determine whether the response is required further comprises:
determining the first text is received from a first user;
determining a recipient of the first text;
determining whether the recipient is a second user; and
in response to determining that the recipient is the second user, determining that the response is required.

15. The method of claim 12, wherein applying the input filter to the first text to determine whether the response is required further comprises:
determining a log probability that the first text is requesting the response; and
determining that the response is required based on the log probability.

16. A non-transitory, computer-readable medium, comprising instructions that, when executed by one or more processors, cause operations comprising:
receiving a first input token;
processing the first input token through a first classification engine to generate a first probability array, wherein the first probability array comprises a first plurality of potential classifications for the first input token and respective probabilities for each of the first plurality of potential classifications;
processing the first plurality of potential classifications to determine a first set of synonymous classifications among the first plurality of potential classifications; and
determining a final classification for the first input token based on the first set.

17. The non-transitory, computer-readable medium of claim 16, wherein the operations further comprise:
determining a first aggregated probability for the first set based on aggregating the respective probabilities for each of the first plurality of potential classifications in the first set;
processing the first plurality of potential classifications to determine a second set of synonymous classifications among the first plurality of potential classifications;
determining a second aggregated probability for the second set based on aggregating the respective probabilities for each of the first plurality of potential classifications in the second set; and
comparing the first aggregated probability and the second aggregated probability.

18. The non-transitory, computer-readable medium of claim 16, wherein determining the final classification for the first input token based on the first aggregated probability further comprises:
determining a first aggregated probability for the first set based on aggregating the respective probabilities for each of the first plurality of potential classifications in the first set;
receiving a threshold probability; and
comparing the first aggregated probability to the threshold probability to determine whether to use a classification assigned to the first set as the final classification.

19. The non-transitory, computer-readable medium of claim 16, wherein determining the final classification for the first input token further comprises:
retrieving a classification assigned to the first set; and
selecting the classification as the final classification.

20. The non-transitory, computer-readable medium of claim 16, wherein the operations further comprise:
receiving a second input token;
processing the second input token through the first classification engine to generate a second probability array, wherein the second probability array comprises a second plurality of potential classifications for the second input token; and
generating a third probability array based on combining the first plurality of potential classifications and the second plurality of potential classifications.
